(19) United States
(12) Patent Application Publication
(10) Pub. No.: US 2004/0151816 A1
(43) Pub. Date: Aug. 5, 2004

(54) Soft serve ice cream and method for preparation

(76) Inventors: Ravi Nana, Munster, IN (US); Gerald R. Schwetlik, Valparaiso, IN (US)

Correspondence Address: Grace P. Malilay, Esq., Cargill, Incorporated Law/24, 15407 McGinty Road W, Wayzata, MN, 55391, US

(21) Appl. No.: 10/356,124

(22) Filed: Jan. 31, 2003

(51) Int. Cl. A23L 1/236

(52) U.S. Cl. 426/548

(57) ABSTRACT

A novel no sugar-added soft serve ice cream composition is disclosed comprising erythritol, full fat milk, cream, skim milk, stabilizers, egg yolk, vanilla extract, sucralose, and a component selected from maltodextrin, alkalized cocoa powder, chocolate liquor, or a blend of cocoa powder and chocolate liquor. Also disclosed is a process for producing the no sugar-added, erythritol-containing soft serve cream compositions.

### FIELD OF THE INVENTION

The present invention relates to soft serve ice cream compositions and a method for preparation of the ice cream.

### SUMMARY OF THE INVENTION

The present invention relates to no sugar-added soft serve ice cream compositions that contain erythritol as an ingredient. The ice cream compositions comprise full fat milk, cream containing 40% fat, erythritol, skim milk powder, a blend of stabilizers, egg yolk, vanilla extract, sucralose powder, and a component selected from maltodextrin, alkalized cocoa powder, chocolate liquor, or a blend of cocoa powder and chocolate liquor. Also provided in this invention is a method for preparing the soft serve ice cream compositions.

### DETAILED DESCRIPTION OF THE INVENTION

The present invention relates to no sugar-added soft serve ice cream compositions that contain erythritol as an ingredient. The ice cream compositions comprise full fat milk, cream containing 40% fat, erythritol, skim milk powder, a blend of stabilizers, fresh egg yolk, vanilla extract, sucralose powder, and a component selected from maltodextrin, alkalized cocoa powder, chocolate liquor, or a blend of cocoa powder and chocolate liquor. Also provided in this invention is a method for preparing the soft serve ice cream compositions.

In more detail, the soft serve ice cream compositions are comprised of about 64.000 to about 66.000 weight % full fat milk, about 12.000 weight % cream containing about 40% fat, from about 9.000 to about 9.300 weight % erythritol, from about 4.893 to about 6.000 weight % skim milk powder, about 1.400 weight % egg yolk, from about 0.500 to about 1.100 weight % vanilla extract, from about 0.004 to about 0.007 weight % sucralose powder, about 0.200 weight % of a stabilizer blend of guar gum, xanthan gum, maltodextrin and carrageenan, and from about 5.700 to about 6.296 weight % of a component selected from a component selected from maltodextrin, alkalized cocoa powder, chocolate liquor, or a blend of cocoa powder and chocolate liquor.

The method for preparing the soft serve ice cream compositions is comprised as follows:

(a) The erythritol, skim milk powder, stabilizer blend, sucralose, and a component selected from a component selected from maltodextrin, alkalized cocoa powder, chocolate liquor, or a blend of cocoa powder and chocolate liquor, ingredients are mixed in a blender at room temperature for about 5 minutes to provide a dry mix blend;

(b) The dry mix blend of step (a) is added to the full fat milk and cream containing about 40% fat, and the mixture is mixed for about 1 to 2 minutes until the mixture is dispersed;

(c) To the mixture resulting from step (b), there is added the egg yolk, and then the vanilla extract;

(d) The mixture resulting from step (c) is then pasteurized by heating at a room temperature of about 70° C. to about 80° C. for about 15 minutes;

(e) The resulting pasteurized mixture is then homogenized in a mixer/blender at a high speed, such as 5000 rpm (revolutions per minute) for about 5 to 10 minutes; and

(f) The resulting homogenized mixture is then cooled to a temperature of about 4.4° C. (about 40° F.) in a suitable apparatus such as a refrigerator.

In regard to the above described soft serve ice cream compositions, the stabilizer blend is a proprietary blend of guar gum, xanthan gum, maltodextrin and carrageenan. The stabilizer blend is available from TIC Gums, Inc., Baltimore, Md., under the name STAB SOFT SERVE.

It has been found that the calorie reduction obtained for the soft serve ice cream compositions of the present invention is about 25% compared to sugar-based soft serve ice cream compositions.

The invention will be more readily understood by reference to the following examples. There are, of course, many other forms of the invention which will become obvious to one skilled in the art, once the invention has been fully disclosed, and it will accordingly be recognized that these examples are given for the purpose of illustration only, and are not to be construed as limiting the scope of this invention in any way.

### EXAMPLES

### Example 1

In Example 1, there is shown the preparation of a no sugar-added soft serve vanilla ice cream. The ingredients of the soft serve vanilla ice cream composition are comprised as follows:

| Ingredients | Weight % |
|---|---|
| Milk (full fat) | 64.000 |
| Cream 40% fat | 12.000 |
| Erythritol | 9.000 |
| Milk powder, skim | 6.000 |
| Maltodextrin | 6.296 |
| Stabilizer blend* | 0.200 |
| Egg yolk | 1.400 |
| Vanilla extract | 1.100 |
| Sucralose powder | 0.004 |

*guar gum, xanthan gum, maltodextrin and carrageenan blend

The soft serve ice cream was prepared by mixing the erythritol, skim milk powder, maltodextrin, stabilizer blend, and sucralose, in a blender for about 5 minutes at room temperature to provide a dry blend. The resulting dry blend was then mixed with the full fat milk and cream containing 40% fat for about 1-2 minutes until a dispersion was obtained. To the dispersion there was then added egg yolk and thereafter the vanilla extract. Then the resulting mixture was pasteurized at a room temperature of 70° C. to 80° C. for about 15 minutes. The pasteurized mixture was then homogenized in a mixer/blender at a speed of about 5000 rpm for about 5-10 minutes. The resultant homogenized mixture was then cooled to a temperature of about 4.4° C. (about 40° C. (about 40° F.) in a refrigerator

### Example 2

In this example there was produced a no sugar-added soft serve chocolate ice cream composition. The ingredients utilized in producing the soft serve chocolate ice cream are comprised as follows:

| Ingredients | Weight % |
|---|---|
| Milk (full fat) | 66.000 |
| Cream 40% fat | 12.000 |
| Erythritol | 9.300 |
| Milk powder, skim | 4.893 |
| Alkalized cocoa powder | 5.700 |
| Stabilizers* | 0.200 |
| Egg yolk | 1.400 |
| Vanilla extract | 0.500 |
| Sucralose powder | 0.007 |

*guar gum, xanthan gum, maltodextrin and carrageenan blend

The soft serve chocolate ice cream was prepared as follows. The erythritol, skim milk powder, cocoa powder, stabilizer blend and sucralose ingredients were mixed for about 5 minutes in a blender at room temperature to produce a dry blend. The full fat milk and cream containing 40% fat were added to the resultant dry blend, and the mixture was mixed for about 1-2 minutes until a dispersion was obtained. Egg yolk and then the vanilla extract were added to the dispersion. The mixture was then pasteurized at a temperature of 70° C. to 80° C. for 15 minutes. The pasteurized mixture was then homogenized in a mixer/blender at a speed of 5000 rpm for about 5-10 minutes. The homogenized mixture was then cooled to a temperature of about 4.4° C. (about 40° F.) in a refrigerator.

It should be clearly understood that the forms of the invention herein described are illustrative only and are not intended to limit the scope of the invention. The present invention includes all modifications falling within the scope of the following claims.

We claim:

1. An ice ream composition comprising on a weight basis:
(a) from about 64.000% to about 66.000% full fat milk,
(b) about 12.000% cream containing about 40% fat,
(c) from about 9.000% to about 9.300% erythritol,
(d) from about 4.893% to about 6.000% skim milk,
(e) about 1.400% egg yolk,
(f) from about 0.500% to about 1.100% vanilla extract,
(g) from about 0.004% to about 0.007% sucralose,
(h) about 0.200% of a stabilizer blend of guar gum, xanthan gum, maltodextrin and carrageenan, and
(i) from about 5.700% to about 6.296% of a component selected from the group consisting of maltodextrin, cocoa, chocolate liquor, and a blend of cocoa and chocolate liquor.

2. The ice cream composition according to claim 1 wherein the full fat milk is present in an amount of about 64.000%, the erythritol is present in an amount of about 9.000%, the skim milk is present in an amount of about 6.000%, the vanilla extract is present in an amount of about 1.100%, the sucralose is present in an amount of about 0.004%, and the component is maltodextrin present in an amount of about 6.296%.

3. The ice cream composition according to claim 1 wherein the full fat milk is present in an amount of about 66.000%, the erythritol is present in an amount of about 9.300%, the skim milk is present in an amount of about 4.893%, the vanilla extract is present in an amount of about 0.500%, the sucralose is present in an amount of about 0.007%, and the component is cocoa present in an amount of about 5.700%.

4. A process for preparing an ice cream composition comprising:
(a) introducing erythritol, skim milk, stabilizer blend, sucralose, and a component selected from the group consisting of maltodextrin and cocoa, into a blender and mixing for about 5 minutes at room temperature thereby producing a dry blend,
(b) introducing full fat milk and cream containing about 40% fat into the dry blend of step (a) and mixing for about 1 to 2 minutes to produce a dispersed mixture,
(c) introducing egg yolk and thereafter vanilla extract into the dispersed mixture of step (b),
(d) pasteurizing the resultant mixture of step (c) at a temperature of from about 70° C. to about 80° C. for a period of about 15 minutes, to produce a pasteurized mixture,
(e) homogenizing the pasteurized mixture of step (d) in a mixer/blender at high speed for a period of about 5 to about 10 minutes, and
(f) cooling the homogenized mixture of step (e) to a temperature of about 4.4° C.

5. The process according to claim 4 wherein the component is maltodextrin.

6. The process according to claim 4 wherein the component is cocoa.

7. The process according to claim 4 wherein the component is chocolate liquor

8. The process according to claim 4 wherein the component is a blend of cocoa and chocolate liquor.

9. The process according to claim 4 wherein the speed is about 5000 revolutions per minute.
